(19) United States
(12) Patent Application Publication
(10) Pub. No.: US 2026/0175371 A1
(43) Pub. Date: Jun. 25, 2026

(54) Adjustable Wrench

(71) Applicant: Hong-Ru Chen, Taichung City (TW)

(72) Inventor: Hong-Ru Chen, Taichung City (TW)

(21) Appl. No.: 18/986,855

(22) Filed: Dec. 19, 2024

(51) Int. Cl. B25B 13/14

(52) U.S. Cl. CPC B25B 13/14

(57) ABSTRACT

An adjustable wrench includes a first body and a second body connected with the first body. The first body is provided with a first mounting portion, a second mounting portion, a third mounting portion, a first operation end, and a first rotation portion. The first mounting portion includes two first faces, two second faces, a third face, two fourth faces, and two end portions. The third face has an arcuate shape. Each of the two second faces is between one of the two first faces and the third face. The third face connects the two second faces. Each of the two end portions is provided on a corner of one of the two first faces. In a two-dimensional view, the third face constructs a first circle, an axis, and a first radius.

### BACKGROUND OF THE INVENTION

### Field of the Invention

The present invention relates to a wrench or spanner and, more particularly, to an adjustable wrench for operating a screw member.

### Description of the Related Art

A conventional adjustable wrench was disclosed in the U.S. Patent No. 2004/0035262, and comprises a handle 2 having an end provided with a fixed jaw 4, and a movable jaw 3 mounted on the handle 2 and movable relative to the fixed jaw 4. The end of the handle 2 is provided with a groove 5 and two rails 6. The groove 5 is located between the two rails 6. The movable jaw 3 is provided with two notches 7 mounted on the two rails 6 so that the movable jaw 3 is movable on the two rails 6 of the handle 2. When in use, the movable jaw 3is movable relative to the fixed jaw 4 to clamp a screw member. Thus, the movable jaw 3 cooperates with the fixed jaw 4 to drive and rotate the screw member.

However, the conventional adjustable wrench has the following disadvantages.
1. The two rails 6 of the handle 2 expand outward from two sides of the groove 5 so that the tolerance between the two rails 6 of the handle 2 and the two notches 7 of the movable jaw 3 is increased gradually due to an excessive extent of outward expansion of the two rails 6 when the movable jaw 3 is used to drive and rotate the screw member. In addition, the movable jaw 3 is initially forged and then worked to form the two notches 7 which need operation of a milling cutter, thereby complicating the working process and increasing the cost of fabrication.
2. The handle 2 and the movable jaw 3 are not available for another conventional adjustable wrench with a general specification so that the parts of the adjustable wrench cannot be exchanged, thereby limiting the versatility of the adjustable wrench.
3. The adjustable wrench is provided with the two rails 6 and the two notches 7. The two rails 6 and the two notches 7 are limited by the volume of the adjustable wrench, so that the two rails 6 and the two notches 7 cannot made to have a larger volume, thereby limiting the locking mechanism between the two rails 6 and the two notches 7.

### BRIEF SUMMARY OF THE INVENTION

The primary objective of the present invention is to provide an adjustable wrench having the optimum tolerance.

In accordance with the present invention, there is provided an adjustable wrench comprising a first body and a second body connected with the first body. The first body is provided with a first mounting portion, a second mounting portion, a third mounting portion, a first operation end, and a first rotation portion. The first mounting portion includes two first faces, two second faces, a third face, two fourth faces, and two end portions. The third face has an arcuate shape. Each of the two second faces is between one of the two first faces and the third face. The third face connects the two second faces. Each of the two end portions is provided on a corner of one of the two first faces. In a two-dimensional view, the third face constructs a first circle, an axis, and a first radius. A first distance is defined between each of the two end portions and the axis. Each of the two second faces has a length defining a second distance. A first angle is defined between each of the two first faces and one of the two second faces. A third distance is defined between each of the two end portions and the third mounting portion.

According to the primary advantage of the present invention, when the first body is expanded outward, the third face is expanded outward from its bottom toward two sides thereof. The two first faces and the two second faces are very close to the bottom of the third face, so that the two first faces and the two second faces have a less extent of outward expansion. Thus, a better tolerance can be maintained between the two first faces and the two fifth faces, and a better tolerance can be maintained between the two second faces and the two sixth faces. In such a manner, a tolerance is defined by the first mounting portion and the fourth mounting portion to allow a sliding movement between the first body and the second body.

According to another advantage of the present invention, the fourth mounting portion is mounted on the first mounting portion, the fifth mounting portion is mounted on the second mounting portion, and the sixth mounting portion is mounted on the third mounting portion so that the adjustable wrench has three fitting and locking mechanisms.

According to a further advantage of the present invention, the first mounting portion is provided with the two first faces, the two second faces, the third face, and the two fourth faces. The first angle is defined between each of the two first faces and one of the two second faces. The two fifth faces are mounted on the two first faces in a first (or vertical) direction, the two sixth faces are mounted on the two second faces in a second (or horizontal) direction, and the two seventh faces are mounted on the third face by an arc face, so that the first mounting portion of the first body is mounted on the fourth mounting portion of the second body by three different fitting modes. Thus, the first mounting portion of the first body and the fourth mounting portion of the second body have a better structural support.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of an adjustable wrench in accordance with the preferred embodiment of the present invention.

FIG. 2 is a side view of a first body of the adjustable wrench in accordance with the preferred embodiment of the present invention.

FIG. 3 is a locally enlarged view of the first body of the adjustable wrench taken along circle A as shown in FIG. 2.

FIG. 4 is a side view of a second body of the adjustable wrench in accordance with the preferred embodiment of the present invention.

FIG. 5 is a perspective view of the adjustable wrench in accordance with the preferred embodiment of the present invention.

FIG. 6 is a side view of the adjustable wrench in accordance with the preferred embodiment of the present invention.

FIG. 7 is a perspective view of a second body of an adjustable wrench in accordance with the second preferred embodiment of the present invention.

FIG. 8 is a side view of the adjustable wrench in accordance with the second preferred embodiment of the present invention.

FIG. 9 is a side view of a first body of the adjustable wrench in accordance with the third preferred embodiment of the present invention.

FIG. 10 is a perspective view of the adjustable wrench in accordance with the third preferred embodiment of the present invention.

FIG. 11 is a side view of a first body of an adjustable wrench in accordance with the fourth preferred embodiment of the present invention.

FIG. 12 is a side view of a first body of an adjustable wrench in accordance with the fifth preferred embodiment of the present invention.

### DETAILED DESCRIPTION OF THE INVENTION

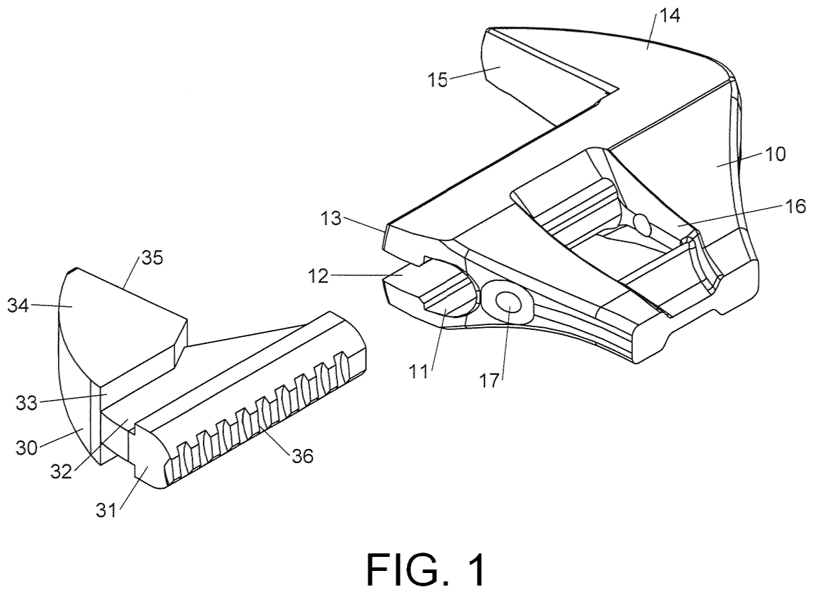

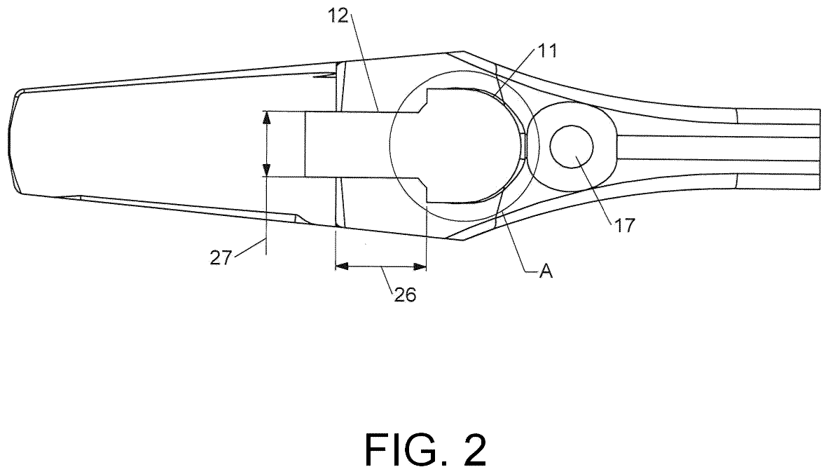

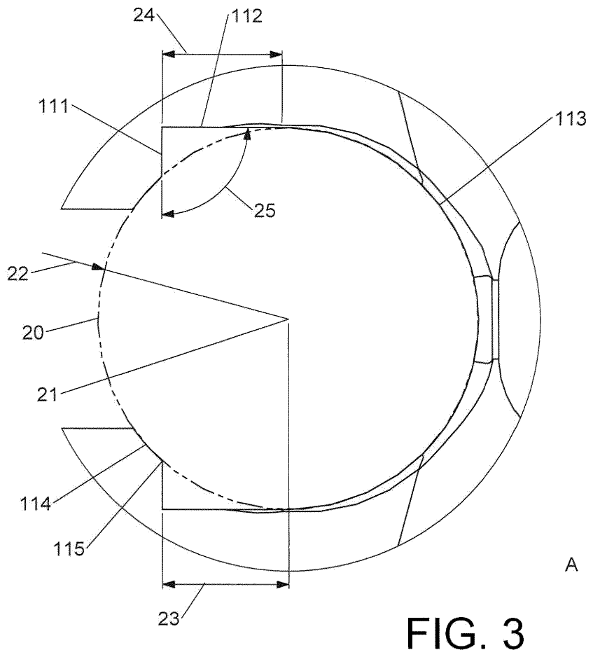

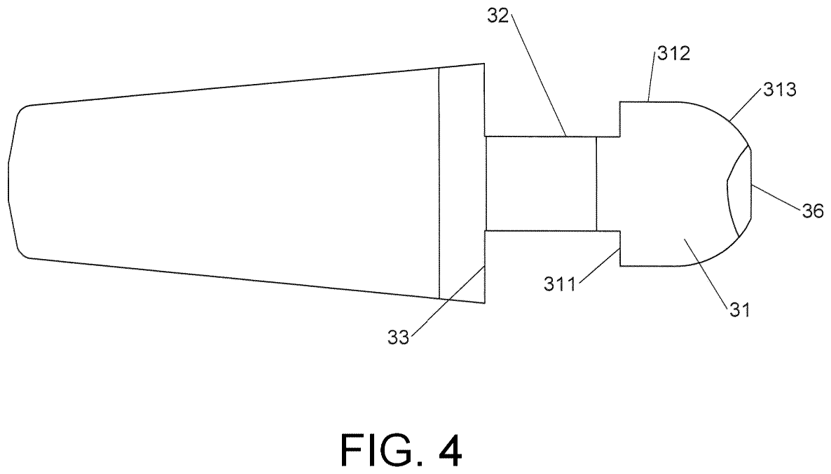

Referring to the drawings and initially to FIGS. 1-6, an adjustable wrench in accordance with the preferred embodiment of the present invention comprises a first body (or fixed jaw) 10 and a second body (or movable jaw) 30.

The first body 10 is provided with a first mounting portion 11. The first mounting portion 11 has a side provided with a second mounting portion 12. The second mounting portion 12 is connected to the first mounting portion 11. The second mounting portion 12 is a transverse open slot having two parallel faces. The second mounting portion 12 has a side provided with a third mounting portion 13 having a planar shape. The third mounting portion 13 is perpendicular to the second mounting portion 12 or almost perpendicular to the second mounting portion 12. The first body 10 is provided with a first operation (or action) end 14. The first operation end 14 is provided with a first rotation portion 15 having a planar shape or a toothed shape. The first body 10 is provided with a slot 16 penetrating the first body 10. The slot 16 is connected to the first mounting portion 11. The first body 10 is provided with a pivot hole 17 located bedside the first mounting portion 11. The pivot hole 17 extends in a direction the same as that of the first mounting portion 11. The pivot hole 17 is connected to the slot 16.

The first mounting portion 11 includes two first faces 111, two second faces 112, a third face 113, two fourth faces 114, and two end portions 115. Each of the two first faces 111 has a planar shape. Each of the two second faces 112 has a planar shape. The third face 113 has an arcuate shape. Preferably, the third face 113 is a single arc. Each of the two second faces 112 is between one of the two first faces 111 and the third face 113. The third face 113 connects the two second faces 112. The third face 113 is tangent to the two second faces 112. Each of the two fourth faces 114 is an arc. Each of the two first faces 111 and each of the two second faces 112 are between the third face 113 and one of the two fourth faces 114. Each of the two end portions 115 is provided on a corner of one of the two first faces 111. Each of the two end portions 115 is located at an intersection of one of the two first faces 111 and one of the two fourth faces 114. The two first faces 111, the two second faces 112, the two fourth faces 114, and the two end portions 115 are arranged symmetrically relative to the third face 113.

Each of the two first faces 111 is parallel with or almost parallel with the third mounting portion 13. Each of the two second faces 112 is parallel with or almost parallel with the second mounting portion 12.

In a two-dimensional view, the third face 113 constructs a first circle 20 having an axis 21 and a first radius 22. Each of the two fourth faces 114 coincides with the first circle 20. The axis 21 is a center of each of the two fourth faces 114. Each of the two fourth faces 114 and the third face 113 have the first circle 20, the axis 21, and the first radius 22. The first circle 20 passes the two end portions 115.

A first distance 23 is defined between each of the two end portions 115 and the axis 21. Each of the two second faces 112 has a length defining a second distance 24. A first angle 25 is defined between each of the two first faces 111 and one of the two second faces 112. A third distance 26 is defined between each of the two end portions 115 and the third mounting portion 13. A fourth distance 27 is defined between the two parallel faces of the second mounting portion 12. The first distance 23 is equal to the second distance 24 or the first distance 23 is more than the second distance 24. The first angle 25 is equal to 90° or the first angle 25 is ranged between 80° and 100° or the first angle 25 is ranged between 85° and 95°. The fourth distance 27 is less than two times of the first radius 22 and more than the first radius 22.

The third distance 26 has the maximum value. The third distance 26 is more than the fourth distance 27. The fourth distance 27 is more than the first radius 22. The first radius 22 is more than the first distance 23. The third distance 26 is ranged between 1.4 times to 1.8 times of the first radius 22. The fourth distance 27 is ranged between 1.1 times to 1.3 times of the first radius 22. The first radius 22 is ranged between 1.2 times to 1.8 times of the first distance 23.

The second body 30 is provided with a fourth mounting portion 31 mounted on the first mounting portion 11. The fourth mounting portion 31 includes two fifth faces 311, two sixth faces 312, and two seventh faces 313. The two fifth faces 311 align with the two first faces 111. The two sixth faces 312 align with the two second faces 112. The two seventh faces 313 align with the third face 113. The fourth mounting portion 31 has a side provided with a fifth mounting portion 32 mounted on the second mounting portion 12. The fifth mounting portion 32 has a side provided with a sixth mounting portion 33 mounted on the third mounting portion 13. The sixth mounting portion 33 has a planar shape. The second body 30 is provided with a second operation (or action) end 34. The second operation end 34 is provided with a second rotation portion 35 aligning with the first rotation portion 15. The fourth mounting portion 31 has a side provided with an engaging portion 36 exposed from the slot 16. The engaging portion 36 is disposed between the two seventh faces 313. The engaging portion 36 has a helical toothed shape or is a linear toothed rack.

The fourth mounting portion 31 is mounted on the first mounting portion 11, the fifth mounting portion 32 is mounted on the second mounting portion 12, and the sixth mounting portion 33 is mounted on the third mounting portion 13, so that the second body 30 is slidable on the first mounting portion 11, the second mounting portion 12, and the third mounting portion 13 of the first body 10, and the second rotation portion 35 is movable relative to the first rotation portion 15. Thus, the second rotation portion 35 cooperates with the first rotation portion 15 to drive and rotate a screw member.

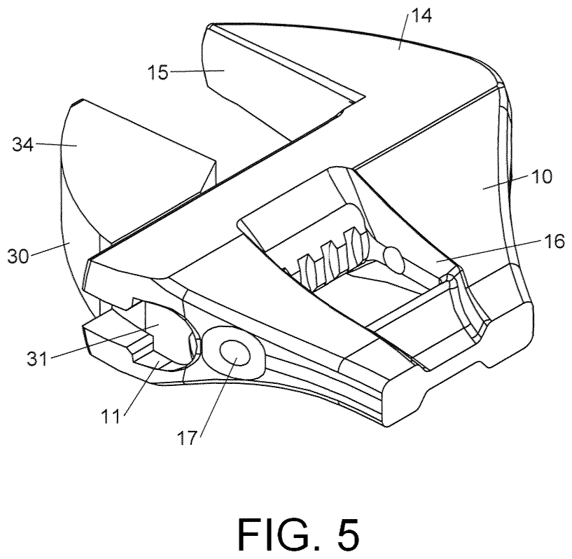

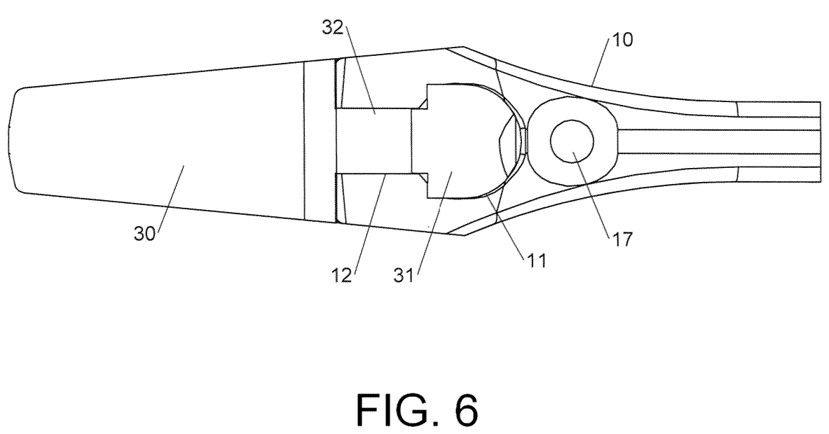

Referring to FIGS. 5 and 6 with reference to FIGS. 1-4, the two fifth faces 311 align with the two first faces 111, the two sixth faces 312 align with the two second faces 112, and the two seventh faces 313 align with the third face 113, so that the first mounting portion 11 is mounted on the fourth mounting portion 31 by a horizontal face, a vertical face and an arcuate face. Thus, the first mounting portion 11 and the fourth mounting portion 31 are fit by three different faces.

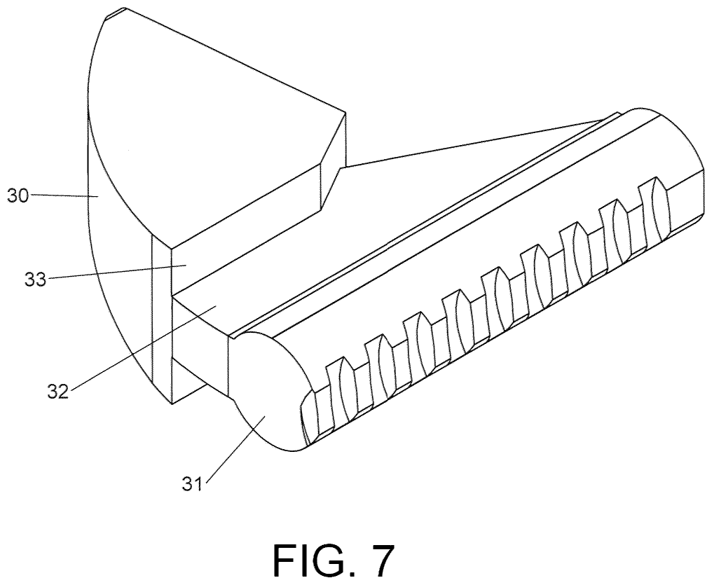

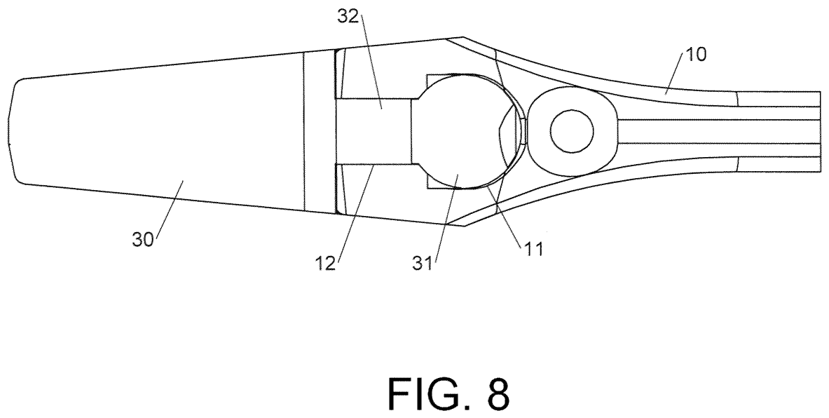

Referring to FIGS. 7 and 8 with reference to FIGS. 1-6, the two fifth faces 311 and the two sixth faces 312 of the fourth mounting portion 31 are undefined. The fourth mounting portion 31 is a cylindrical block having a conventional structure. The fourth mounting portion 31 is mounted on the first mounting portion 11, with the third face 113, the two fourth faces 114, and the two end portions 115 abutting the fourth mounting portion 31. Thus, the second body 30 is slidably mounted on the first body 10. In practice, the second body 30 is available for a conventional adjustable wrench with a general specification.

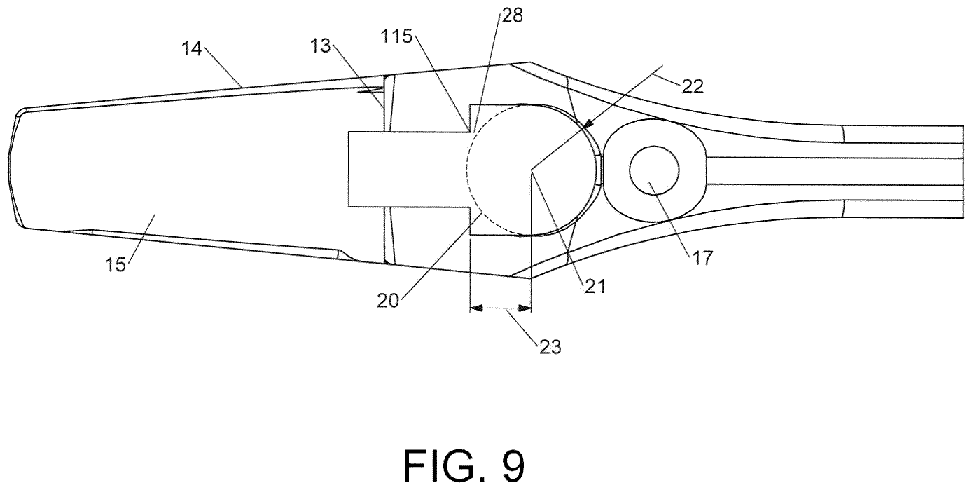

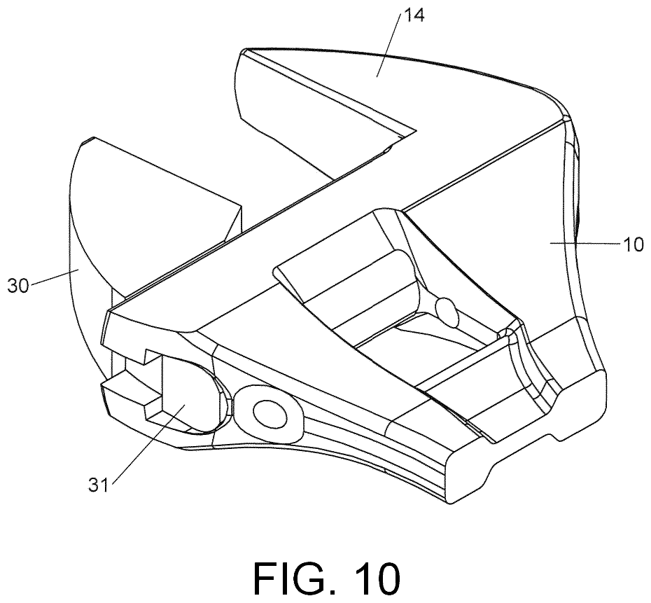

Referring to FIGS. 9 and 10 with reference to FIGS. 1-6, the two fourth faces 114 of the first body 10 are undefined. A gap 28 is defined between the first circle 20 and each of the two end portions 115. Alternatively, the gap 28 between the first circle 20 and each of the two end portions 115 is undefined.

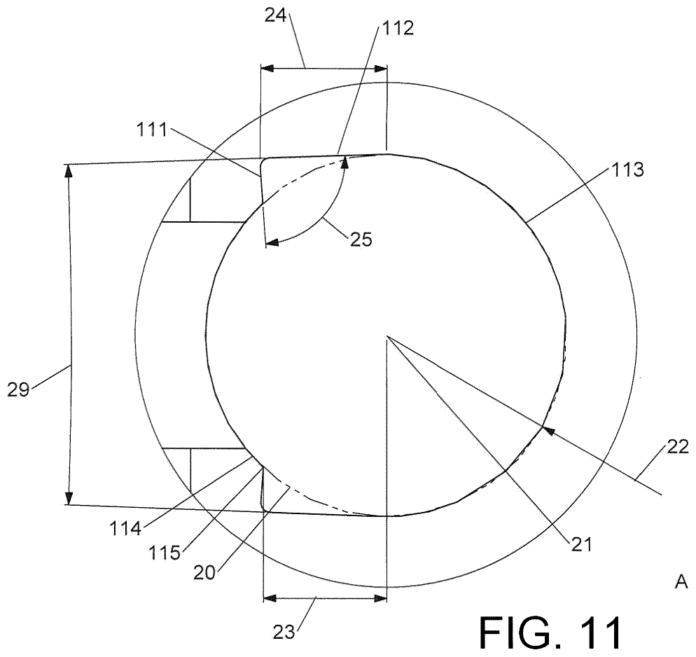

Referring to FIG. 11 with reference to FIGS. 1-6, the two second faces 112 are not parallel with each other. A second angle 29 is defined between the two second faces 112. The second angle 29 is less than 10° or the second angle 29 is less than 5°.

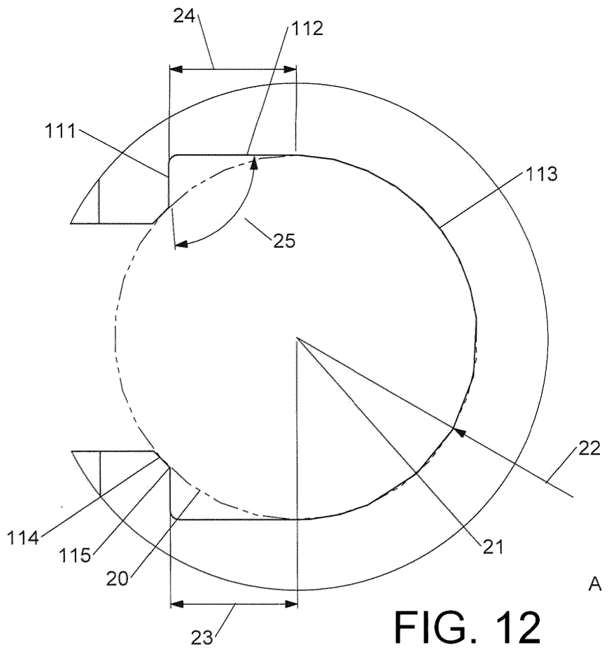

Referring to FIG. 12 with reference to FIGS. 1-6, each of the two fourth faces 114 has a planar shape and is tangent to the first circle 20. Alternatively, each of the two fourth faces 114 has a convex shape and is tangent to the first circle 20.

In another preferred embodiment of the present invention, each of the two first faces 111 and one of the two second faces 112 have an intersection formed with a chamfered angle having a round shape or a bevel shaped. When the first angle 25 is less than 90°, each of the two first faces 111 has a determined length, and each of the two fourth faces 114 has a length that is changed by variation of the first angle 25.

Accordingly, the adjustable wrench of the present invention has the following advantages.
1. When the first body 10 is expanded outward, the third face 113 is expanded outward from its bottom toward two sides thereof. The two first faces 111 and the two second faces 112 are very close to the bottom of the third face 113, so that the two first faces 111 and the two second faces 112 have a less extent of outward expansion. Thus, a better tolerance can be maintained between the two first faces 111 and the two fifth faces 311, and a better tolerance can be maintained between the two second faces 112 and the two sixth faces 312. In such a manner, a tolerance is defined by the first mounting portion 11 and the fourth mounting portion 31 to allow a sliding movement between the first body 10 and the second body 30.
2. The fourth mounting portion 31 is mounted on the first mounting portion 11, the fifth mounting portion 32 is mounted on the second mounting portion 12, and the sixth mounting portion 33 is mounted on the third mounting portion 13, so that the adjustable wrench has three fitting and locking mechanisms.
3. the first mounting portion 11 is provided with the two first faces 111, the two second faces 112, the third face 113, and the two fourth faces 114. The first angle 25 is defined between each of the two first faces 111 and one of the two second faces 112. The two fifth faces 311 are mounted on the two first faces 111 in a first (or vertical) direction, the two sixth faces 312 are mounted on the two second faces 112 in a second (or horizontal) direction, and the two seventh faces 313 are mounted on the third face 113 by an arc face, so that the first mounting portion 11 of the first body 10 is mounted on the fourth mounting portion 31 of the second body 30 by three different fitting modes. Thus, the first mounting portion 11 of the first body 10 and the fourth mounting portion 31 of the second body 30 have a better structural support.
4. The fifth mounting portion 32 is mounted on the second mounting portion 12 to provide a support in the second direction, and the two sixth faces 312 rest on the two second faces 112 to provide a support in the second direction, so that the first body 10 and the second body 30 have two support locations in the second direction at two different positions. The sixth mounting portion 33 is mounted on the third mounting portion 13 to provide a support in the first direction, and the two fifth faces 311 rest on the two first faces 111 to provide a support in the second direction, so that the first body 10 and the second body 30 have two support locations in the first direction at two different positions. Thus, the first body 10 and the second body 30 have two support locations in the first direction and two support locations in the second direction, so that the adjustable wrench has a better support and will be rotated easily.
5. When the first body 10 and the second body 30 are driven by a rotational force, the two second faces 112 provide an area to withstand a force in the first direction, and the two first faces 111 provide an area to withstand a force in the second direction, so that the first body 10 and the second body 30 have a better rotational torque.
6. The adjustable wrench of the present invention has a basic fitting structure similar to that of a conventional adjustable wrench. The first mounting portion 11 and the fourth mounting portion 31 have three different support modes including the support in the first direction, the support in the second direction, and the support of an arcuate face, so that the adjustable wrench has a better structural support.
7. The fourth mounting portion 31 is provided with the two fifth faces 311, the two sixth faces 312, and the two seventh faces 313. The two fifth faces 311 and the two sixth faces 312 increase the volume of the fourth mounting portion 31 and provide an area to withstand a force in the first direction and the second direction, so that the fourth mounting portion 31 has a better structural support.
8. The first mounting portion 11 is provided with the two fourth faces 114 and the two end portions 115. As shown in FIG. 7, the second body 30 is available for a conventional adjustable wrench with a general specification. The two fourth faces 114 and the two end portions 115 rest on the fourth mounting portion 31, so that the second body 30 is mounted on the first body 10. Thus, the first body 10 is assembled with the second body 30 that is available for a conventional adjustable wrench with a general specification to enhance the versatility of the adjustable wrench.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An adjustable wrench comprising:
a first body and a second body;
wherein:
the first body is provided with a first mounting portion;
the first mounting portion has a side provided with a second mounting portion;
the second mounting portion is connected to the first mounting portion;
the second mounting portion is a transverse open slot having two parallel faces;
the second mounting portion has a side provided with a third mounting portion having a planar shape;
the third mounting portion is perpendicular to the second mounting portion or almost perpendicular to the second mounting portion;
the first body is provided with a first operation end;
the first operation end is provided with a first rotation portion having a planar shape or a toothed shape;
the first mounting portion includes two first faces, two second faces, a third face, two fourth faces, and two end portions;
each of the two first faces has a planar shape;
each of the two second faces has a planar shape;
the third face has an arcuate shape;
each of the two second faces is between one of the two first faces and the third face;
the third face connects the two second faces;
the third face is tangent to the two second faces;
each of the two fourth faces is an arc;
each of the two first faces and each of the two second faces are between the third face and one of the two fourth faces;
each of the two end portions is provided on a corner of one of the two first faces;
each of the two end portions is located at an intersection of one of the two first faces and one of the two fourth faces;
the two first faces, the two second faces, the two fourth faces, and the two end portions are arranged symmetrically relative to the third face;
each of the two first faces is parallel with or almost parallel with the third mounting portion;
each of the two second faces is parallel with or almost parallel with the second mounting portion;
in a two-dimensional view, the third face constructs a first circle having an axis and a first radius;
each of the two fourth faces coincides with the first circle;
the axis is a center of each of the two fourth faces;
each of the two fourth faces and the third face have the first circle, the axis, and the first radius;
the first circle passes the two end portions;
a first distance is defined between each of the two end portions and the axis;
each of the two second faces has a length defining a second distance;
a first angle is defined between each of the two first faces and one of the two second faces;
a third distance is defined between each of the two end portions and the third mounting portion;
a fourth distance is defined between the two parallel faces of the second mounting portion;
the first distance is equal to the second distance or the first distance is more than the second distance;
the fourth distance is less than two times of the first radius and more than the first radius;
the third distance has the maximum value;
the third distance is more than the fourth distance;
the fourth distance is more than the first radius;
the first radius is more than the first distance;
the second body is provided with a fourth mounting portion mounted on the first mounting portion;
the fourth mounting portion includes two fifth faces, two sixth faces, and two seventh faces;
the two fifth faces align with the two first faces;
the two sixth faces align with the two second faces;
the two seventh faces align with the third face;
the fourth mounting portion has a side provided with a fifth mounting portion mounted on the second mounting portion;
the fifth mounting portion has a side provided with a sixth mounting portion mounted on the third mounting portion;
the sixth mounting portion has a planar shape;
the second body is provided with a second operation end;
the second operation end is provided with a second rotation portion aligning with the first rotation portion;
the fourth mounting portion has a side provided with an engaging portion exposed from the slot;
the engaging portion is disposed between the two seventh faces;
the engaging portion has a helical toothed shape or is a linear toothed rack;
the fourth mounting portion is mounted on the first mounting portion, the fifth mounting portion is mounted on the second mounting portion, and the sixth mounting portion is mounted on the third mounting portion, so that the second body is slidable on the first mounting portion, the second mounting portion, and the third mounting portion of the first body, and the second rotation portion is movable relative to the first rotation portion.

2. The adjustable wrench as claimed in claim 1, wherein:
the first body is provided with a slot penetrating the first body;
the slot is connected to the first mounting portion;
the first body is provided with a pivot hole located bedside the first mounting portion;
the pivot hole extends in a direction the same as that of the first mounting portion; and
the pivot hole is connected to the slot.

3. The adjustable wrench as claimed in claim 1, wherein the third face is a single arc.

4. The adjustable wrench as claimed in claim 1, wherein:
the first angle is equal to 90° or the first angle is ranged between 80° and 100° or the first angle is ranged between 85° and 95°;
the third distance is ranged between 1.4 times to 1.8 times of the first radius;
the fourth distance is ranged between 1.1 times to 1.3 times of the first radius; and
the first radius is ranged between 1.2 times to 1.8 times of the first distance.

5. The adjustable wrench as claimed in claim 1, wherein:
the fourth mounting portion is a cylindrical block;
the fourth mounting portion is mounted on the first mounting portion, with the third face, the two fourth faces, and the two end portions abutting the fourth mounting portion; and
the second body is slidably mounted on the first body.

6. The adjustable wrench as claimed in claim 1, wherein a gap is defined between the first circle and each of the two end portions.

7. The adjustable wrench as claimed in claim 1, wherein:
the two second faces are not parallel with each other;
a second angle is defined between the two second faces; and
the second angle is less than 10°or the second angle is less than 5°.

8. The adjustable wrench as claimed in claim 3, wherein:
each of the two fourth faces has a planar shape and is tangent to the first circle; or
each of the two fourth faces has a convex shape and is tangent to the first circle.

9. The adjustable wrench as claimed in claim 1, wherein:
each of the two first faces and one of the two second faces have an intersection formed with a chamfered angle having a round shape or a bevel shaped; and
when the first angle is less than 90°, each of the two first faces has a determined length, and each of the two fourth faces has a length that is changed by variation of the first angle.
